(19) United States
(12) Patent Application Publication
(10) Pub. No.: US 2009/0223266 A1
(43) Pub. Date: Sep. 10, 2009

(54) Method and Deodorizing and Decontaminating Biologically Contaminated Sludge

(75) Inventors: Janos Stadler, Budapest (HU); Peter Szabo, Budapest (HU); Ferenc Puskas, Tatabanya (HU)

Correspondence Address: YOUNG & THOMPSON, 209 Madison Street, Suite 500, ALEXANDRIA, VA, 22314, US

(73) Assignee: COMPAT-LINCENCIA KFT, Budapest (HU)

(21) Appl. No.: 11/665,051

(22) PCT Filed: Oct. 11, 2005
(86) PCT No.: PCT/HU2005/000112

§ 371 Date: Jul. 11, 2007

(30) Foreign Application Priority Data
Oct. 11, 2004 (HU) P0402055

(51) Int. Cl. C05F 3/04

(52) U.S. Cl. 71/12

(57) ABSTRACT

The present invention relates to an environmentally friendly method for deodorizing and rendering innocuous biologically contaminated sludge or slurry—primarily municipal wastewater sludge or liquid manure—containing up to 10% of solid matter with aerobic stabilization. The method comprises adding adsorbent carbonaceous mineral material having a particle size of less than or equal to 5 mm to the sludge or slurry and processing the obtained mixture by wet grinding to form a stable suspension in such a way that the solid content of the mixture is ground to particles having a particle size of less than 200 μm and the living organisms are lysed.

The present invention relates to a process for deodorizing and rendering innocuous biologically contaminated sludges with a solid content of less than or equal to 10% with aerobic stabilization.

The greatest problem in the environmentally friendly purification of wastewater (of human and animal origin) is the handling and disposal of the sludges formed during the water purifying process. The sludge is difficult to treat because it almost always stinks and is also contaminated with different pathogens. The final disposal is also difficult as there are concerns even about the agricultural use of non-toxic and heavy metal free sludges.

According to the most commonly accepted view the soil is the most appropriate place for final disposal of the municipal sludges primarily of human origin and of the liquid manure of the stock-farms. Owing to the appropriately designed disposal, the soil ensures the reintegration of the materials into the nature via its purifying mechanisms [Géza Öllös, Operation of sewage treatment plants (Szennyvíztisztító telepek üzemeltetése) II, 431-435, Akadémiai Kiadó, Budapest (1995)].

The relevant legal regulation in Hungary (Government decree No. 50/2001 about the rules of handling and utilizing wastewater and sludge) permits the use of sewage sludges subjected to preliminary biological, chemical and heat treatment only after six months in agricultural land if certain parameters are within the allowable limits (for particulars see Articles 3 and 4 and the annex of said decree). The majority of sewage sludges originating from municipal wastewater treatment do not comply with these requirements. From the sludge treatments in use only the digested sludges considered as compost meet those quality standards, which are more or less acceptable for agricultural use. The cost of establishing such wastewater treatment plants based on anaerobic technology widely exceeds the cost of the common wastewater treatment plants using aerobic technology, further, building up of such plants is only possible up to a certain capacity. Their continuous operation is furthermore strongly affected by the weather conditions.

There are different known methods published in the literature for treating wastewater, especially municipal sewage.

The Hungarian patent No. 189069 describes a process for treating sludge resulting from the biological treatment of sewage. According to the process the sludge from the pre-sedimentation tank or the mixture of this sludge and thickened activated sludge is treated under anaerobic conditions and the anaerobically decomposed sludge is then thickened and dewatered. The drawback of the process is that it requires a pre-sedimentation step and aeration must be carried out often for several days, thus the process can be regarded as inefficient.

Another process for utilizing municipal sewage sludges is described in the Hungarian patent No. 209112. According to the process 100 weight parts of partially dewatered municipal sewage sludge containing 20 to 45 wt % water is admixed with 10 to 30 weight parts of a mixture containing 70 to 95% rhyolite tuff, 30-50 wt % ground bauxite, and optionally 5 to 20 wt % zeolite and further 0.1 to 0.3 weight parts of culture medium containing bacterium megantherium evenly distributed on the surface of the ground material; the homogenized mixture is packed into prisms and aged for 60 to 90 days under continuous watering. Although the resulting sludge can be used in the agriculture, the large place needed for forming prisms and the long (90 days) ageing period are disadvantageous.

A process for the environmental utilization and disposal of sewage sludge and/or other organic waste containing material (e.g. liquid manure) is offered in the Hungarian patent No. 192230. According to the disclosed process the solid content of the sewage sludge is adjusted to not more than 15%, the sewage sludge is homogenized and eventually admixed with auxiliary agents e.g. with caustic mud and/or fertilizers and after an interim storage it is injected into the soil in 20 to 40 cm depth. Although the process requires minimal investment and can be operated with low cost, its use is disadvantageous in view of the problems connected with the soil injecting method to achieve the appropriate soil-covering, and further the need of interim storage of the voluminous liquid, dilute sludge.

The object of the invention was to overcome the disadvantages of the state of the art processes and work out an environmental and simple process for treating sludges and slurries, which enables the quick and efficient stabilization of large quantities of said materials in such a way that the resulting product should comply with both the requirements of legal regulations and the sound environmental expectations so is appropriate for re-circulating into the soil or utilizing for energetical purposes.

The main inventive idea behind the invention is the recognition that by a wet grinding step, causing very strong mechano-chemical impingement, the biologically contaminated sludge can be converted to a stable suspension, if the contaminated sludge is subjected to a radical mechanical wet grinding together with carbonaceous mineral materials and/or clay minerals. We believe that during the radical wet grinding of the mixture containing the sludge or slurry to be treated and an appropriate quantity of carbonaceous mineral material and/or clay mineral, probably due to the evolving radical mechanical stress and pressure change (in some cases cavitation), the carbon is rheologically digested, its humic substances and the aluminium-hydrosilicates forming part of the dead material are peptizated and form together with the contaminated sludge or slurry a highly tixotropic suspension. As a result of this process, a complex organic-inorganic material is formed, which has organo-mineral hydrosilicate bonds similar to that in the materials of the soil. The contaminated sludge adsorbed on the ground carbonaceous material thus becomes deodorized. Due to the radical effect of impact shear the specific surface of the minerals is increased to several 1000 times and the microbial—and probably other—living organisms are lysed, the cell walls become disrupted. The lysis of the microorganisms is further increased by the abrasive quartz particles present in the carbonaceous mineral material, such as lignite, thus the population of pathogenic microorganisms is decreased by more than one magnitude. It means that because of the aerobic degradation the pathogens in the stabilized suspension gradually die during drying.

It was observed that the process of the invention does not only result in a thick, stable suspension but this had an acceptable, earthy smell thus it became exempt from the typical stink of sewage sludges or liquid manure. It was also observed that the stabilized suspension became dry very soon. Bacteriological tests have shown that the amount of pathogens and bacteria normally always present in such biologically contaminated slurries decreased with the time remarkably.

The desired effects—namely deodorizing and rendering innocuous the biologically contaminated sludge—can be achieved by a single process, according to which to the biologically contaminated sludge or slurry with a solid content of less than or equal to 10% an adsorbent carbonaceous mineral ground material with a particle size of less than or equal to 5 mm is added and the mixture thus obtained is converted by wet grinding to a stable suspension in such a way that the solid content of the mixture is ground to a particle size of less than 200 μ/m, preferably to a particle size of less than 50 μm, and thereby the living organisms are lysed.

The adsorbent carbonaceous mineral material is preferably lignite or young brown coal.

The adsorbent carbonaceous mineral material is preferably added in a ratio of 5 to 35 percent by weight relative to the sludge or slurry.

In addition to the adsorbent carbonaceous mineral material one or more clay minerals can be added, the preferred amount thereof is 5 to 15 weight percent relative to the amount of the sludge or slurry.

The clay mineral is for example zeolite or bentonite.

The process can be carried out continuously or in batch process, using adequate wet grinding apparatus, such as the so-called “Kavitron” apparatus, which is a modified common mud-pump used in mining. For the person skilled in mechanical engineering there are several methods known for achieving high shear (e.g. provoking cavitation), theoretically all of these known methods can be used, e.g. the shearing stress can be increased by increasing the RPM. The duration of the treatment depends on many factors, e.g. the effectiveness of crushing, the RPM, the shearing stress in the apparatus, etc. In the knowledge of the used mineral materials and their particle sizes these parameters can be optimized.

The dewatering of the product obtained by adding mineral materials can be achieved both by natural drying or exsiccation, since the stabilized suspension tends to dry in bulk (i.e. not delaminated) very quickly and the obtained bulk material practically can be regarded as sterile after a couple of months. The air-dry material can be milled and filled into bags, i.e. it is easy to handle.

Due to its high organic material content (40 to 45%) and easy handling the end product obtained can be used as soil-ameliorating or soil-conditioning material, especially in sandy soil for all cultures. However, it can be used for many different kinds of soil and for many different purposes, e.g. for turfing of slopes and stocking. Many analyses, culturing experiments and pilot scale experiments proved the plant growth enhancing effect and the persistent increase of the soil fertility.

Beyond all these, the calorific value of the end product can achieve that of the stone-coal (5000 kcal) thus it can be used either for energetic or for heating purposes.

As described above, the process of the invention has many advantages. The most important advantage is that the process can be applied for almost every kind of municipal wastewater sludge or liquid manure of animal origin, and further, it can be used for stabilizing and treating slurries from other liquid organic wastes (e.g. wastewater sludge of meatworks) as well.

Another advantage of the invention is that the mechano-chemical process offered does not necessitate the addition of any chemicals, it does not produce any toxic materials, moreover, one of the utilized mineral materials, the lignite is one of the soil-conditioning organic materials specified in the degree No. 8/2001 of the Hungarian Ministry of Agricultural and Rural Development. As the process can be applied in the very first step of wastewater treatment to treat the sludge formed by the pre-sedimentation, it makes the use of large amounts of chemicals unnecessary, which is both from the environmental and the economical point of view very advantageous.

Further advantages of the inventive process are the following:
during the wet grinding together with lignite or brown coal the organic species present in the contaminated sludge (primarily bacteria) are mostly disrupted owing to the very strong mechano-chemical impact and shear;
the unpleasant odor of the sludge or slurry is practically turned to the smell of fresh soil;
drying is effectuated in a natural way, which is not possible or proposed for stinking sludges because of the undesired environmental effects.

To sum up, the inventive process achieves in one step and in an environmental way what the state of the art processes achieved in several consecutive steps. Below the inventive process is exemplified by two concrete examples, which are for illustrative purposes only and do not limit the scope of protection.

### EXAMPLE 1

Mixture of raw wastewater sludge and excess sludge from aerobic wastewater treatment (solid content: 3.6%) is admixed with 20% of lignite powder and ground under recirculation in a wet grinding apparatus [type: Kavitron 3/2] with 1750 rpm for 30 minutes, thus achieving impact shear effect. The obtained product is a dark-colored, thick, soil-smelling, stable suspension.

### EXAMPLE 2

Liquid manure from the receiver of a pork-breeder farm is admixed with 28% of lignite powder and 5% of zeolite and treated in a wet grinding apparatus [type: Kavitron 3/2] for 20 minutes at 1450 rpm, thus achieving impact shear. According to the analysis of the National Institute of Animal Health (Budapest) in the thick, dark-colored, deodorized and stabilized suspension the salmonella and coliform infection decreased by one magnitude in 48 hours and after 6 months in the dried material practically no bacteria or other pathogen organism could be detected in the dried material.

1. Process for deodorizing and rendering innocuous biologically contaminated sludge or slurry with a solid content of less than or equal to 10% by aerobic stabilization, wherein an adsorbent carbonaceous mineral ground material with a particle size of less than or equal to 5 mm is added to the sludge or slurry and the mixture thus obtained is converted by wet grinding to a stable suspension in such a way that the solid content of the mixture is ground to a particle size of less than 200 μm and thereby the living organisms are lysed.

2. The process of claim 1, wherein the adsorbent carbonaceous mineral material is lignite or young brown coal.

3. The process of claim 1, wherein the adsorbent carbonaceous mineral material is added in a ratio of 5 to 35 percent by weight relative to the amount of the sludge or slurry.

4. The process according to claim 1, wherein a clay mineral is used in addition to the adsorbent carbonaceous mineral material.

5. The process of claim 4, wherein the clay mineral is used in an amount of 5 to 15 percent by weight relative to the amount of the sludge or slurry.

6. The process of claim 4, wherein the clay mineral is zeolite or bentonite.

7. The process according to claim 1, wherein the solid content of the mixture is ground to a particle size of less than 50 μm.

8. The process of claim 2, wherein the adsorbent carbonaceous mineral material is added in a ratio of 5 to 35 percent by weight relative to the amount of the sludge or slurry.

9. The process according to claim 2, wherein a clay mineral is used in addition to the adsorbent carbonaceous mineral material.

10. The process according to claim 3, wherein a clay mineral is used in addition to the adsorbent carbonaceous mineral material.

11. The process of claim 5, wherein the clay mineral is zeolite or bentonite.

12. The process according to claim 2, wherein the solid content of the mixture is ground to a particle size of less than 50 μm.

13. The process according to claim 3, wherein the solid content of the mixture is ground to a particle size of less than 50 μm.

14. The process according to claim 4, wherein the solid content of the mixture is ground to a particle size of less than 50 μm.

15. The process according to claim 5, wherein the solid content of the mixture is ground to a particle size of less than 50 μm.

16. The process according to claim 6, wherein the solid content of the mixture is ground to a particle size of less than 50 μm.
